(19) United States
(12) Patent Application Publication
(10) Pub. No.: US 2020/0015321 A1
(43) Pub. Date: Jan. 9, 2020

(54) DATA SHARING DETERMINATION DEVICE

(71) Applicant: NTT DOCOMO, INC., Chiyoda-ku (JP)

(72) Inventors: Kouki HAYASHI, Chiyoda-ku (JP); Osamu GOTO, Chiyoda-ku (JP); Noritaka SUGIMOTO, Minato-ku (JP); Takashi OZAKI, Yokohama-shi (JP)

(73) Assignee: NTT DOCOMO, INC., Chiyoda-ku (JP)

(21) Appl. No.: 16/468,171

(22) PCT Filed: Dec. 7, 2017
(86) PCT No.: PCT/JP2017/044039

§ 371 Date: Jun. 10, 2019

(30) Foreign Application Priority Data
Mar. 27, 2017 (JP) 2017-061653

(51) Int. Cl. H04W 92/18; H04W 8/20; H04W 72/02; H04W 4/021; H04L 29/08

(52) U.S. Cl. CPC H04W 92/18; H04W 8/20; H04L 67/306; H04W 4/021; H04W 72/02

(57) ABSTRACT

A data sharing determination device includes a detection unit that detects that two portable terminals are close to each other, a profile information acquisition unit that acquires attribute information indicating an attribute of at least one of users of the two portable terminals detected by the detection unit, a context estimation unit that acquires sensor information of one or a plurality of sensors included in any one of the two portable terminals and estimates a state of at least one of the users based on the sensor information and the attribute information acquired by the profile information acquisition unit, and a shareability determination unit that determines whether or not data is shared between the two portable terminals based on the state of the user which is estimated by the state estimation unit.

### TECHNICAL FIELD

The present invention relates to a data sharing determination device.

### BACKGROUND ART

In the related art, a technique for sharing photographs and the like between a portable terminal owned by a user and a portable terminal of another user has been proposed. For example, Patent Literature 1 discloses a technique for generating an action ID based on positional information and time information regarding a terminal and sharing image data between terminals associated with the same action ID.

### CITATION LIST

### Patent Literature

Patent Literature 1: Japanese Unexamined Patent Publication No. 2013-105422

### SUMMARY OF INVENTION

### Technical Problem

In the related art, data sharing may be allowed by associating users in the same place in the same time slot. In this case, even when the users do not desire to share data, there is a concern that data sharing may be allowed.

An object of an aspect of the present invention is to provide a data sharing determination device that allows data sharing in a state where users desire to share data.

### Solution to Problem

A data sharing determination device according to an aspect of the present invention includes a detection unit that detects that two portable terminals are close to each other, an attribute information acquisition unit that acquires attribute information indicating an attribute of at least one of users of each of the two portable terminals detected by the detection unit, a state estimation unit that acquires sensor information of one or a plurality of sensors included in either one of the two portable terminals and estimates a state of at least one of the users based on the sensor information and the attribute information acquired by the attribute information acquisition unit, and a shareability determination unit that determines whether or not data may be shared between the two portable terminals based on the state of the user which is estimated by the state estimation unit.

In the data sharing determination device, two portable terminals close to each other are detected by the detection unit. Among the two portable terminals, one portable terminal is a candidate which is a sharing destination of data of the other portable terminal. The shareability determination unit determines whether or not data can be shared between the users based on the state of any user which is estimated by the state estimation unit. Here, not only sensor information acquired from the portable terminal but also attribute information of at least one user is used for the state estimation in the state estimation unit. For this reason, it is possible accurately determine a state between the users and to determine whether or not the users desire to share data. Therefore, it is possible to allow data sharing in a state where the users desire to share data.

### Advantageous Effects of Invention

According to an aspect of the present invention, it is possible to provide a data sharing determination device that allows data sharing in a state where users desire to share data.

### BRIEF DESCRIPTION OF DRAWINGS

FIG. 1 is a conceptual diagram of a data sharing system using a data sharing determination device according to an embodiment.

FIG. 2 is a functional block diagram of the data sharing system.

FIG. 3 is a diagram conceptually illustrating profile information.

FIG. 4 illustrates an example of a table showing rules of context estimation.

FIG. 5 illustrates a sequence showing a process (context estimation) executed by the data sharing system.

FIG. 6 illustrates a sequence showing a process (data sharing process) executed by the data sharing system.

FIG. 7 is a diagram illustrating hardware configurations of a portable terminal and a server device.

### DESCRIPTION OF EMBODIMENTS

Hereinafter, an embodiment according to the present invention will be described in detail with reference to the accompanying drawings. For convenience, substantially the same components will be denoted by the same reference numerals, and the description thereof may be omitted.

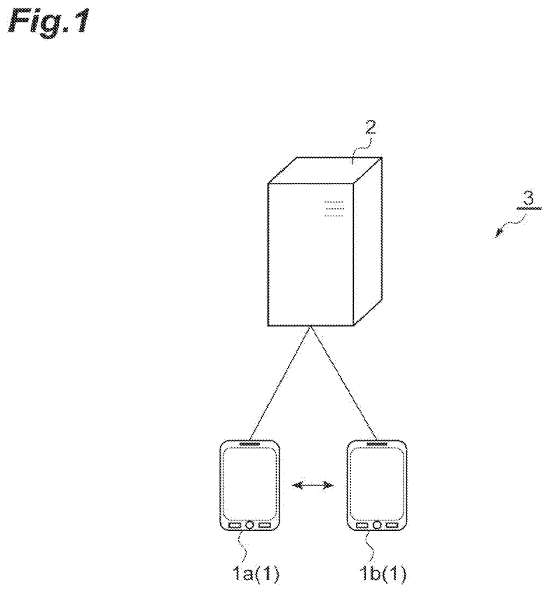

FIG. 1 is a conceptual diagram of a data sharing system using a data sharing determination device according to an embodiment. In the present embodiment, a data sharing system 3 includes a plurality of portable terminals 1 and a profile estimation server 2, and the data sharing determination device is constituted by the portable terminal 1. Meanwhile, in the present embodiment, data sharing may be executed between the plurality of portable terminals 1, but FIG. 1 illustrates an example in which data is shared between two portable terminals. Hereinafter, an example in a case where photograph data captured by one portable terminal 1b is shared with another portable terminal 1a between two portable terminals will be described. In this example, for example, when a user is in an usual state such as during travel, it is determined that users desire to share data, and the data sharing is allowed. Meanwhile, in the following description, the portable terminal 1a and the portable terminal 1b may be referred to as the other terminal and its own terminal, respectively.

The portable terminal 1 is a device used by being carried by a user. Specifically, the portable terminal 1 is an information processing terminal such as a smartphone, a mobile phone, a tablet terminal, a personal digital assistant (PDA), or a personal computer. The portable terminal 1 has a function of performing wireless communication by being connected to a network such as a mobile communication network. The portable terminal 1 is constituted by hardware such as a central processing unit (CPU), a memory, and a communication module.

The profile estimation server 2 is an information processing terminal such as a server computer. The profile estimation server 2 is constituted by hardware such as a CPU, a memory, and a communication module. In the data sharing system 3, the portable terminal 1 and the profile estimation server 2 can communicate with each other through a network and may transmit and receive information to and from each other.

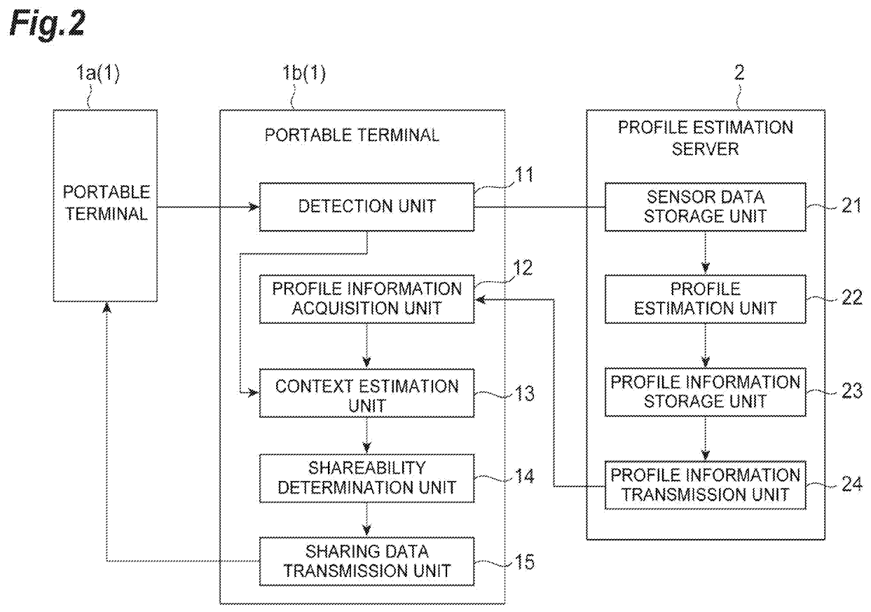

FIG. 2 is a functional block diagram of a portable terminal as a shareability determination device and a profile estimation server. As illustrated in FIG. 2, the portable terminal 1b includes a detection unit 11, a profile information acquisition unit (attribute information acquisition unit) 12, a context estimation unit (state estimation unit) 13, a shareability determination unit 14, and a sharing data transmission unit 15. Meanwhile, the portable terminal 1a is also configured to include the same functional blocks as those of the portable terminal 1b.

The detection unit 11 detects that two portable terminals 1a and 1b are close to each other. In the present embodiment, the detection unit 11 of one portable terminal 1b detects the other near portable terminal 1a. A state where the portable terminals 1a and 1b are close to each other is a state where the portable terminal 1a is within a predetermined range centering on the portable terminal 1b, and for example, is a state where it can be determined that two users of the portable terminals 1a and 1b are acting together. As an example, it can be determined that two portable terminals 1a and 1b are close to each other in a case where the portable terminal 1a is within a range of several meters centering around the portable terminal 1b. Specifically, the detection unit 11 detects the closeness of the portable terminal 1a by detecting radio waves of near-field wireless communication such as Bluetooth (registered trademark) or WiFi (registered trademark) which are emitted from the portable terminal 1a by using a communication module. In addition, the detection unit 11 may detect the closeness of the portable terminal 1a using a microphone, a peripheral mode of Bluetooth low energy (BLE), a long term evolution (LTE) direct technique, or the like.

The detection unit 11 of the portable terminal 1b acquires information on the portable terminal 1a or information on the user of the portable terminal 1a (hereinafter, referring to as “close terminal information”) when detecting the close portable terminal 1a. For example, radio waves of near-field wireless communication which are emitted from the portable terminal 1a include identification information of the portable terminal 1a (for example, a MAC address), identification information of the user of the portable terminal 1a (for example, a user ID), and the like. The detection unit 11 of the portable terminal 1b may acquire the identification information thereof included in the detected radio waves as close terminal information. The detection unit 11 can output the acquired close terminal information to the profile estimation server 2 and the context estimation unit 13 of its own terminal 1b.

In addition, the detection unit 11 may acquire data obtained by various sensors included in its own terminal 1b. The data acquired by the detection unit 11 includes positional information of its own terminal 1b. The positional information may be information indicating a latitude and a longitude obtained by a global positioning system (GPS). In addition, the positional information may be information based on identification information of a near-field wireless communication device (for example, an access point) which is received from a fixedly disposed near-field wireless communication device such as a WiFi device. In addition, the detection unit 11 can also acquire data indicating a time when each data is acquired as a portion of the data of the sensor. The detection unit 11 can detect data of the sensor on a regular basis. The detection unit 11 outputs the detected data of the sensor to the profile estimation server 2 together with identification information of its own terminal (hereinafter, referred to as “its own terminal information”). In addition, the detection unit 11 outputs the detected data of the sensor to the context estimation unit 13.

The profile information acquisition unit 12 acquires profile information (attribute information) indicating an attribute of at least one of users of two portable terminals 1a and 1b detected by the detection unit 11. That is, the profile information acquisition unit 12 in the portable terminal 1b acquires at least one of profile information of the user of its own terminal 1b and profile information of the user of the portable terminal 1a. In the present embodiment, the profile information acquisition unit 12 acquires, for example, the profile information of the user of its own terminal 1b. The profile information acquired by the profile information acquisition unit 12 may be, for example, an association profile indicating an association between users, a place profile indicating the meaning given to a place for a user, and the like. The association profile indicates in what position (for example, a family member, a colleague, a friend, or the like) the user of the other portable terminal 1 is when seen from the user of its own terminal 1b. The place profile indicates what a place indicated by positional information means to the user (for example, a home, a work place, or the like).

In the present embodiment, the profile information acquisition unit 12 acquires profile information from the profile estimation server 2. Here, an example of the profile estimation server 2 will be described. The profile estimation server 2 estimates a user's attributes for each portable terminal 1 and stores the estimated attributes in association with identification information of the user. As illustrated in FIG. 2, the profile estimation server 2 includes a sensor data storage unit 21, a profile estimation unit 22, a profile information storage unit 23, and a profile information transmission unit 24.

The sensor data storage unit 21 receives its own terminal information, close terminal information, and data on a sensor from the portable terminal 1b and stores the received information and data. In addition, the sensor data storage unit 21 can output the stored data to the profile estimation unit 22. Meanwhile, the sensor data storage unit 21 receives data on a sensor in the other portable terminal 1a from the portable terminal 1a and stores the received data. Data on a sensor received from each portable terminal 1 is stored in association with identification information of each portable terminal 1.

The profile estimation unit 22 estimates attributes for each user based on data acquired from the sensor data storage unit 21. In the present embodiment, the profile estimation unit 22 estimates at least a place profile and an association profile as profile information. The place profile is classification information of the meaning given to a place for each user. The meaning given to a place (positional information) for each user may vary depending on a time. For this reason, in the present embodiment, the meaning given to a date and time for a user is included in a place profile.

The profile estimation unit 22 estimates (derives) information in which positional information and a meaning of the positional information are associated with each other as a place profile. For example, the profile estimation unit 22 associates a meaning such as a home, a work place, work (business trip), eating out, and leisure with positional information of a place where a user visits. Meanwhile, in a case where a user is estimated to be a student, the meaning of a “work place” may be regarded as a “school”.

As examples, WiFi identification information acquired from a portable terminal, information indicating a latitude and a longitude obtained by GPS, and the like may be used for the estimation of a place profile as positional information. For example, the profile estimation unit 22 may extract positional information detected in respective time slots of each day of the week (hereinafter, referred to as “date and time information”) based on the acquired positional information and the like. Through this process, the date and time information and the positional information are associated with each other. The profile estimation unit 22 gives the meaning to a place by a statistical method based on the positional information associated with the date and time information.

More specifically, the profile estimation unit 22 extracts a set of pieces of positional information positionally close to each other by performing clustering on the history of the positional information. In this case, identification information of WiFi may be replaced with information indicating a latitude and a longitude using a correspondence table between identification information and a latitude and a longitude stored in advance. The profile estimation unit 22 acquires respective extracted sets of positional information as “bases”. The profile estimation unit 22 derives visiting data for a user for the acquired base. The visiting data may be, for example, data on a visiting date and time of the user at each base. Subsequently, the profile estimation unit 22 estimates the meaning given to each base for a user. For example, a visiting day number rate indicating on how many days each base was visited during a predetermined time period (for example, over the past six months) may be used for this determination. For example, the number of visiting days is “1” in both a case where a base is visited only once a day and a case where a base is visited a plurality of times a day. The visiting day number rate is derived based on visiting data. As an example, the meaning of a base where the ranking of the visiting day number rate is the first place may be regarded as a “home”. In addition, the meaning of a base where the ranking of the visiting day number rate is the second place to the tenth place, the frequency of visiting per week is one day or more, and an average visiting time on a visiting day is equal to or more than 200 minutes may be regarded as a “work place”.

In addition, the profile estimation unit 22 estimates whether respective days of the week are attendance days or holidays based on the visiting days of the week for an area estimated as a workplace. Further, the profile estimation unit 22 gives the meaning to another base based on a result of the estimation of an attendance day or a holiday and time-slot information of visiting at a base. In this case, for example, the meaning of abase where a visiting days proportion during daylight of weekdays is equal to or more than a predetermined value (for example, 0.3 or the like) may be regarded as a “business trip”. Here, weekdays are the working days of a user, and the visiting days proportion is the proportion of the number of days on which the user visits on weekdays. In addition, the meaning of a base where an average visiting time during daylight is equal to or less than a predetermined period of time (for example, 20 minutes) and an average visiting time at night is equal to or more than a predetermined period of time (for example, 60 minutes) may be regarded as “eating out”. In addition, the meaning of a base where an average visiting time is equal to or more than a predetermined period of time (for example, 30 minutes) and is not applicable to a “business trip” and “eating out” may be regarded as “leisure”. The meaning given to positional information for a user may be performed by another known method. Meanwhile, map information in which positional information and category information in an area (facility) are associated with each other may be referred to for the estimation of the place profile. The category information is, for example, information indicating features of the area, and is a “commercial facility”, a “restaurant”, an “amusement facility”, a “business district”, or the like as an example.

The association profile is profile information of an association between users, and includes relationship information indicating a relationship between users and intimacy information indicating an intimacy degree between users. As an example, close terminal information of the close portable terminal 1a acquired from the portable terminal 1b, data of the place profile estimated by the profile estimation unit 22, and the like are used for the estimation of the association profile. The profile estimation unit 22 classifies a relationship between the user of its own terminal 1b and the user of the other terminal 1a as a “family member”, a “friend”, a “colleague”, a “work-related person”, an “acquaintance”, or the like, and acquires the classified relationship as relationship information.

For example, the profile estimation unit 22 extracts close terminal information detected at each base estimated as a place profile. The profile estimation unit 22 classifies the user of the other terminal as any one of a “family member”, a “friend”, a “colleague”, a “work-related person”, and an “acquaintance” based on the history of close terminal information at each base. For example, in a case where its own terminal 1b and the other terminal 1a are close to each other in a place estimated to be a “home” of the user of its own terminal 1b and the place is estimated to be a “home” for the user of the other terminal 1a, the user of the other terminal 1a may be estimated as a “family member”. As an example, the users of the portable terminals 1a and 1b having consistent positional information of a “home” estimated as a place profile and close to each other for a period of time equal to or more than a predetermined proportion (for example, 50%) in a visiting time at “home” are estimated as “family members”.

Further, in a case where its own terminal 1b and the other terminal 1a are close to each other at the same time in a place estimated to be a “home” of the user of its own terminal 1b and the place is estimated to be “leisure” for the user of the other terminal 1a, the user of the other terminal 1a may be estimated as a “friend”.

Further, in a case where its own terminal 1b and the other terminal 1a are close to each other at the same time in a place estimated to be a “work place” of the user of its own terminal 1b and the place is estimated to be a “work place” for the user of the other terminal 1a, the user of the other terminal 1a may be estimated as a “colleague”. As an example, in a case where pieces of positional information of the estimated “work places” are consistent with each other and a period of time during which its own terminal 1b and the other terminal 1a are close to each other (hereinafter, referred to as an “encounter time”) for a week in a “work place” is equal to or more than a predetermined period of time (for example, 50 minutes), the users of the portable terminals 1a and 1b may be estimated as “colleagues”.

In addition, another user whose maximum encounter time in a day is equal to or more than a predetermined period of time (for example, 30 minutes) may be estimated as an “acquaintance”. In addition, a user who is a user applicable to an “acquaintance”, is a person other than a colleague, and encounters at a “work place” of the user of its own terminal 1b or the other terminal 1a may be estimated as a “work-related person”. For example, in a case where the user of the other terminal 1a also visits at the same time in a place estimated to be a “work place” of the user of its own terminal 1b and the place is estimated to be a “business trip destination” for the user of the other terminal 1a, the user of the other terminal 1a may be estimated as a “work-related person”. Meanwhile, in a case where another user is applicable to two or more of a “family member”, a “friend”, a “colleague”, a “work-related person”, and an “acquaintance”, a relationship may be estimated in accordance with a priority order of “family member”>“friend”>“colleague”>“work-related person”>“acquaintance”.

In addition, the profile estimation unit 22 may calculate an intimacy degree between the user of its own terminal 1b and the user of the other terminal 1a. For example, the profile estimation unit 22 can estimate an intimacy degree between the user of its own terminal 1b and the user of the other terminal 1a by relative evaluation with all users for which a relationship with the user of its own terminal 1b is estimated as a population. As an example, the rate of encounter with an encounter party, an average encounter time of a day, the number of encounter bases, and the like may be used for the evaluation of an intimacy degree. The rate of encounter with an encounter party may be, for example, ((the number of encounter days for a predetermined period)÷(the number of days for the predetermined period)). The “the number of encounter days” is the number of days when it is detected that its own terminal 1b and the other terminal 1a are close to each other. The average encounter time of a day may be, for example, ((an encounter time on the first day+ . . . +an encounter time on the n-th day)÷(the number of encounter days)). The number of encounter bases may be the number of bases where an encounter with an encounter party has occurred for a predetermined period (for example, for the past six months). As the values of the rate of encounter with an encounter party, the average encounter time of a day, and the number of encounter bases increase, a higher intimacy degree is evaluated. The intimacy degree may be expressed as a numerical value, for example, within a range where a minimum value is set to 0 and a maximum value is set to 100.

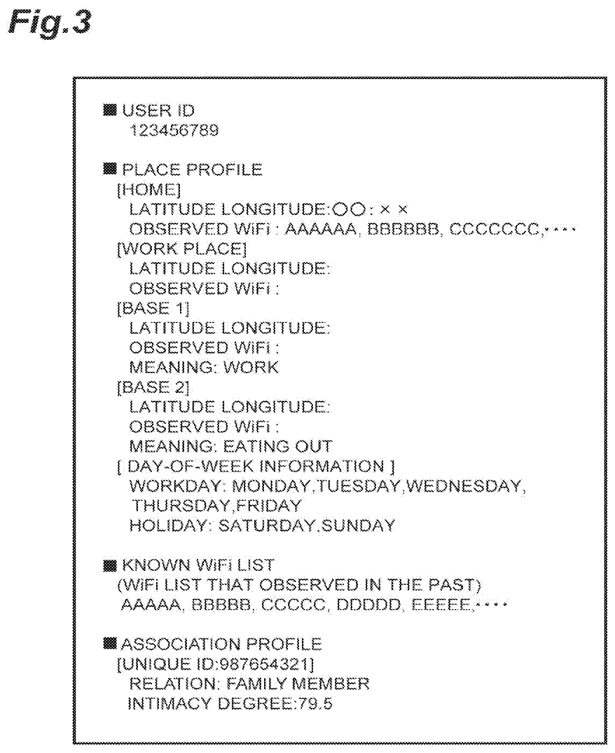

The profile information estimated by the profile estimation unit 22 is stored in the profile information storage unit 23. An example of the profile information stored in the profile information storage unit 23 is illustrated in FIG. 3. As illustrated in FIG. 3, the profile information includes a user ID, and a place profile and an association profile associated with the user ID. As illustrated in the drawing, in information of the place profile, positional information of a latitude and a longitude and identification information of observed WiFi are associated with each other for a home, a work place, and bases. Meanwhile, in the example illustrated in the drawing, only one piece of information on a latitude and a longitude is shown for each base, but the base is a set of pieces of positional information, and thus the information of the place profile may have a plurality of pieces of information on a latitude and a longitude for each base. In the association profile, information of another user related to a user (in the example illustrated in the drawing, relation and intimacy degree) is associated for each of IDs of users. Known identification information of WiFi acquired by the portable terminal 1b in the past may be stored in the profile information storage unit 23.

The profile information stored in the profile information storage unit 23 may be transmitted to the portable terminal 1b by the profile information transmission unit 24. The profile information transmission unit 24 may transmit the profile information to the portable terminal 1b on a regular basis or in a case where a request is given from the portable terminal 1b. Thereby, the profile information acquisition unit 12 of the portable terminal 1b acquires profile information of the user of its own terminal 1b.

Description will return to the portable terminal 1b again. The context estimation unit 13 acquires data of a sensor included in any one of two portable terminals 1a and 1b, and estimates a state of at least one of the users based on the data and the profile information acquired by the profile information acquisition unit 12. In the present embodiment, the present state of the user of its own terminal 1b is estimated by the context estimation unit 13. For example, place estimation, close user estimation, date and time estimation, and context estimation are performed by the context estimation unit 13.

In the place estimation, the meaning given to a base where the user is visiting at present for a user is estimated. For example, the context estimation unit 13 collates the positional information acquired by the detection unit 11 with the profile information. In a case where the meaning is given to a place indicated by the positional information as the profile information, the present position is estimated as any one base such as a home or a work place in accordance with the given meaning. For example, in a case where a latitude and a longitude indicated by information acquired by the detection unit 11 are the same as the latitude and the longitude of a base stored as profile information or within a fixed distance from the latitude and the longitude, the context estimation unit 13 derives the base as an estimation result. Further, in a case where identification information of WiFi acquired by the detection unit 11 is the same as identification information of WiFi of a base stored as profile information, the context estimation unit 13 derives the base as an estimation result.

Further, in a case where there is no constituent positional information as profile information, the present position of a user is estimated to be a first visit place for the user. In this case, information regarding which place the present position of the user is objectively may be acquired based on positional information obtained by a GPS with reference to map information in which positional information and category information are associated with each other. This information may be, for example, a restaurant, a commercial facility (store), an accommodation, an amusement facility, leisure, healthcare, finance, transportation, medical treatment, public, a business district, a residential area, or the like. In addition, a distance from the present position of a user to a base (for example, a home, a work place, or the like) may be calculated based on positional information obtained by a GPS. In this case, for example, the position of the base may be a geographical center position of positions indicated by a plurality of latitudes and longitudes associated with the base.

In the close user estimation, a relationship with the user of the other portable terminal 1a close to the portable terminal 1b is estimated. For example, the context estimation unit 13 collates close terminal information acquired by the detection unit 11 with profile information. In a case where there is relationship information associated with the close terminal information as profile information, a relation with the user of the other portable terminal 1a is estimated to be a relation indicated by relationship information. In a case where there is no relationship information associated with the close terminal information as profile information, a relation with the user of the other portable terminal 1a may be estimated as, for example, “another person”.

In the date and time estimation, it is estimated whether the present is an attendance day or a holiday for the user of its own terminal 1b. For example, the context estimation unit 13 collates the date and time information acquired by the detection unit 11 with the profile information. In this case, whether or not a time slot is one of usually being in a work place may also be inquired.

In the context estimation, the context of a user is estimated based on an estimation result of the present position through place estimation, an estimation result of a close user through close user estimation, and an estimation result through the date and time estimation. In the present embodiment, the context estimation unit 13 stores rules of context estimation in advance and executes the estimation of context in accordance with the rules.

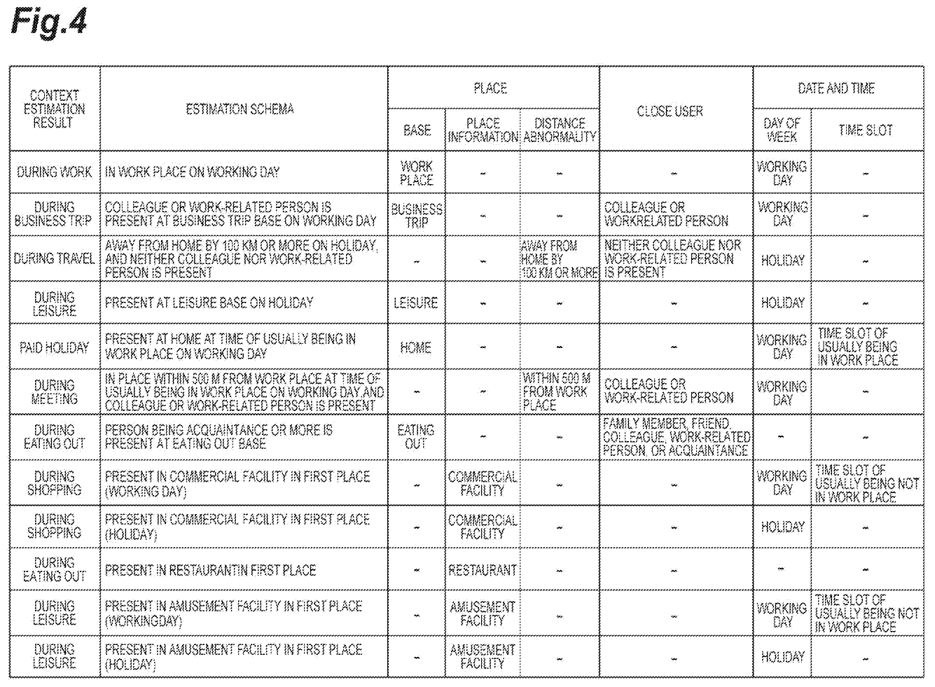

FIG. 4 is a table showing an example of rules of context estimation. As illustrated in FIG. 4, in a case where an estimation result of place estimation indicates a “work place” and an estimation result of date and time estimation indicates a “working day”, it is estimated that a user is in a work place on a working day, and thus the context estimation unit 13 estimates the present state to be “during work”. In a case where a result of place estimation indicates a “business trip”, a result of date and time estimation indicates a “working day”, and a result of close user estimation indicates a “colleague” or a “work-related”, it is estimated that a user is at a business trip base on a working day, and thus the context estimation unit 13 estimates the present state to be “during a business trip”. In a case where a result of place estimation indicates being a long distance away from home (for example, 100 km) or more, a result of date and time estimation indicates a “holiday”, and a result of close user estimation indicates neither a “colleague” nor a “work-related”, it is estimated that a user is in a place other than a work place away from home on a holiday, and thus the context estimation unit 13 estimates the present state to be “during travel”.

In a case where a result of place estimation indicates “leisure” and a result of date and time estimation indicates a “holiday”, it is estimated that a user is at a leisure base on a holiday, and thus the context estimation unit 13 estimates the present state to be “during leisure”. In a case where a result of place estimation indicates a “home” and a result of date and time estimation indicates a “working day” and a time slot of usually being in a work place, it is estimated that a user is at home on a working day, and thus the context estimation unit 13 estimates the present state to be a “paid holiday”. In a case where a result of place estimation indicates being within a short distance (for example, 500 m) from a work place, a result of date and time estimation indicates a “working day”, and a result of close user estimation indicates a “colleague” or a “work-related person”, it is estimated that a user is with a colleague or the like near a work place on a working day, and thus the context estimation unit 13 estimates the present state to be “during meeting”. In a case where a result of place estimation indicates “eating out” and a result of close user estimation indicates any one of a “family member”, a “friend”, a “colleague”, a “work-related”, and an “acquaintance”, it is estimated that a user is with a person equal to or more than an acquaintance at a meal base, and thus the context estimation unit 13 estimates the present state to be “during eating out”.

In a case where a result of place estimation indicates a “commercial facility” other than a base and a result of date and time estimation indicates a “working day” and a time slot of usually being not in a work place, it is estimated that a user is in a commercial facility for the first time outside of a working time, and thus the context estimation unit 13 estimates the present state to be “during shopping”. In a case where a result of place estimation indicates a “commercial facility” other than a base and a result of date and time estimation indicates a “holiday”, it is estimated that a user is in a commercial facility for the first time on a holiday, and thus the context estimation unit 13 estimates the present state to be “during shopping” In a case where a result of place estimation indicates a “restaurant” other than a base, it is estimated that a user is in a restaurant for the first time, and thus the context estimation unit 13 estimates the present state to be “during eating out”. In a case where a result of place estimation indicates an “amusement facility” other than a base and a result of date and time estimation indicates a “working day” and a time slot of usually being not in a work place, it is estimated that a user is in the first amusement facility outside of a working time, and thus the context estimation unit 13 estimates the present state to be “during leisure”. In a case where a result of place estimation indicates an “amusement facility” other than a base and a result of date and time estimation indicates a “holiday”, it is estimated that a user is in an amusement facility on a holiday, and thus the context estimation unit 13 estimates the present state to be “during leisure”.

The shareability determination unit 14 determines whether or not data is shared between two portable terminals 1a and 1b based on a user's state estimated by the context estimation unit 13. For example, the shareability determination unit 14 determines whether or not the user of its own terminal 1b and the user of the other terminal 1a close thereto desire to share data based on an estimation result of the context estimation unit 13. For example, in a case where a close user is a person equal to or more than an “acquaintance”, the intimacy degree with respect to the user is equal to or greater than a predetermined value, and the present state is “during travel”, “during leisure” or “during eating out”, the shareability determination unit 14 allows data sharing.

In a case where the shareability determination unit 14 allows data sharing, the sharing data transmission unit 15 transmits data of the portable terminal 1b to the portable terminal 1a. In this case, data to be determined may be data generated under the state estimated by the context estimation unit 13. For example, in a case where an estimation result of the context estimation unit 13 indicates “during eating out” with an “acquaintance”, only photograph data captured by the portable terminal 1b during eating out with the acquaintance is transmitted from the sharing data transmission unit 15 to the portable terminal 1a.

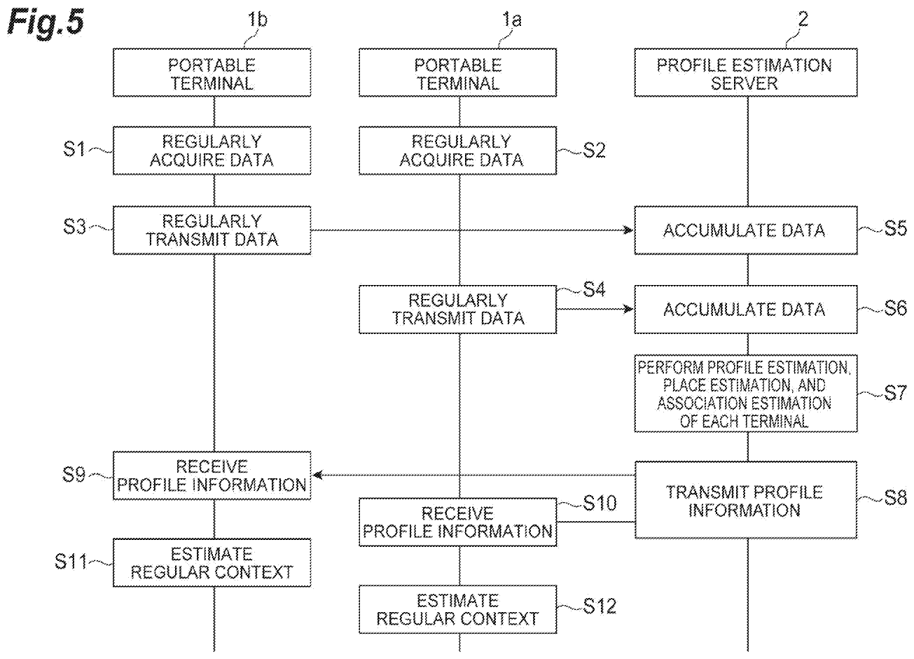

Subsequently, operations of the profile estimation server 2 will be described with reference to a sequence illustrated in FIG. 5. First, the portable terminals 1a and 1b acquires data of sensors by the respective detection units 11 on a regular basis (steps S1 and S2). For example, the detection units 11 of the portable terminals 1a and 1b may acquires data of the sensors every five minutes. In this case, the portable terminals 1a and 1b may accumulate data acquired within a predetermined period. Next, the portable terminals 1a and 1b transmit the acquired data to the profile estimation server 2 (steps S3 and S4). For example, the portable terminals 1a and 1b may transmit the acquired and stored sensor data to the profile estimation server 2 every predetermined period of time (for example, two hours) longer than an interval of data acquisition. In the profile estimation server 2, data of the sensors transmitted from the portable terminals 1a and 1b is accumulated in association with each of pieces of identification information of the portable terminals 1a and 1b (steps S5 and S6). Next, the profile estimation server 2 estimates attributes of the users of the portable terminals 1a and 1b based on the accumulated data of the sensors of the portable terminals 1a and 1b (step S7). For example, the estimation of attributes may be executed every predetermined period of time longer than an interval data transmission performed by the portable terminals 1a and 1b. As an example, the estimation of attributes may be executed once a day. As described above, in the profile estimation server 2, a place profile and an association profile are estimated. Next, the profile estimation server 2 transmits estimated profile information to the portable terminals 1a and 1b (step S8). When the portable terminals 1a and 1b receive the profile information transmitted from the profile estimation server 2 (steps S9 and S10), state estimation is executed at the timing (steps S11 and S12). In this manner, user attribute estimation and state estimation may be executed on a regular basis between the portable terminals 1a and 1b and the profile estimation server 2.

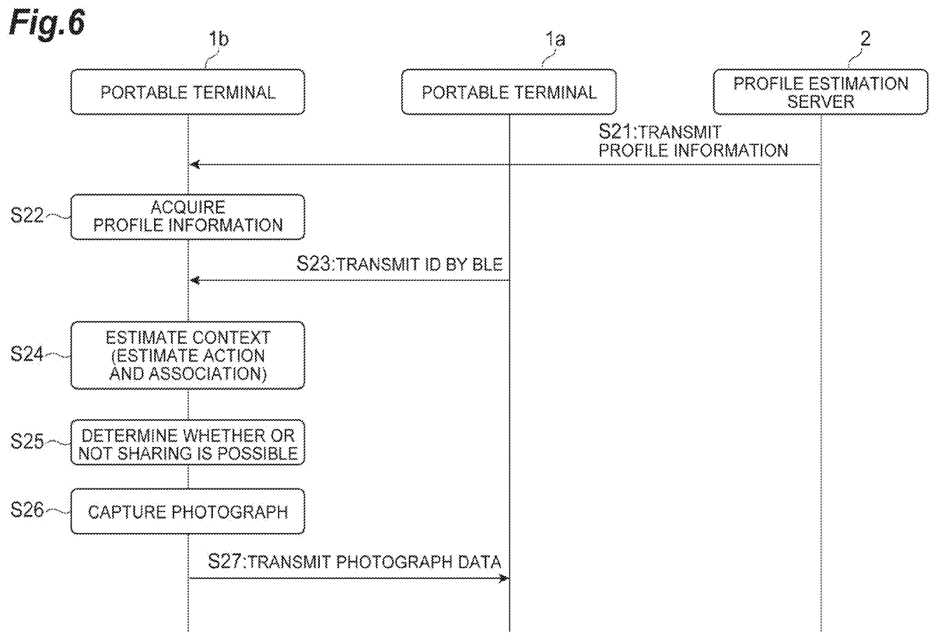

Subsequently, a flow of sharing of photograph data between portable terminals will be described with reference to a sequence illustrated in FIG. 6. First, profile information of the user of the portable terminal 1b is transmitted to the portable terminal 1b of the user by the profile estimation server 2 (step S21). The transmission of the profile information in step S21 may be executed, for example, in a case where the present position of the user is changed. The portable terminal 1b acquires the transmitted profile information (step S22). Next, close terminal information is transmitted to the portable terminal 1b from the portable terminal 1a of another user close to the portable terminal 1b of the user (step S23). The close terminal information may be transmitted by, for example, BLE. That is, in this state, the portable terminal 1b detects that another portable terminal 1a is present in a range close to its own terminal 1b. Meanwhile, in the example of FIG. 6, the user of the portable terminal 1b and the user of the other portable terminal 1a have, for example, a relation of an acquaintance or more having an intimacy degree equal to or more than a fixed level.

Next, the portable terminal 1b estimates the present state by the context estimation unit 13 (step S24). In the portable terminal 1b, the present action of the user and an association with a close user are estimated. Next, in the portable terminal 1b, the shareability determination unit 14 determines whether or not data sharing is possible based on an estimation result in step S24 (step S25). When a photograph is captured by the portable terminal 1b under a state where it is determined in step S25 that data sharing is possible (step S26), the photograph data is transmitted to the portable terminal 1a (step S27). Data transmission may be automatically executed at a timing when a photograph is captured. On the other hand, in a case where it is determined in step S25 that data sharing is not possible, the system is terminated without performing data transmission.

In the above-described portable terminal 1b as a data sharing determination device, a close portable terminal 1a is detected by the detection unit 11. The shareability determination unit 14 determines whether or not data sharing is possible between users based on an estimation result obtained by the context estimation unit 13. Here, not only sensor data acquired from the portable terminal 1b but also profile information on the user is used for the estimation of a state in the context estimation unit 13. For this reason, it is possible to accurately determine the state of the user and to determine whether or not the users desire to share data. Therefore, it is possible to allow data sharing in a state where the users desire to share data. According to such a user sharing determination device, for example, when a user is in an unusual state such as during travel, it is possible to easily share photograph data related to unusualness, and the like with a close user.

In addition, the profile information acquisition unit 12 acquires at least one of relationship information indicating a relationship between users and intimacy information indicating an intimacy degree between the users, as profile information. According to this configuration, it is possible to determine whether or not users close to each other have a relationship in which data sharing is desired. For this reason, for example, data sharing between other persons who were present by chance is suppressed. That is, it is also possible to operate the system without using security means such as a password.

In addition, the profile information acquisition unit 12 acquires classification information of the meaning given to a place or a time for each user, as profile information. According to this configuration, it is possible to more accurately estimate where and what a user is doing and to determine whether or not users desire to share data. For example, in a case where it is assumed that sharing of photograph data is executed during an unusual event such as travel, it is possible to estimate that a user is at work in a case of a work place on a weekday and to easily determine that data sharing is not desired.

In addition, data is generated under a state estimated by the context estimation unit 13. According to this configuration, data generated in a state where users are close to each other is a target to be shared, and thus the sharing of data not desired to be shared is suppressed. For example, photograph data captured during travel of friends may be shared, but photograph data captured when the friends are not acting together is not shared.

In addition, the detection unit 11 detects the other portable terminal out of two portable terminals through near-field wireless communication, and thus it is possible to accurately detect that two portable terminals are close to each other.

Further, in the above-described embodiment, a case where there is one close user has been illustrated, but there may be two or more close users. In this case, even when close terminal information of the second close user is not included in profile information of a user of its own terminal, the shareability determination unit 14 may allow data sharing when a relationship of the second close user is a relation of an acquaintance or more in a close user being an acquaintance of the user or more.

Further, in the above-described embodiment, the present state of a user of its own terminal has been estimated based on attributes of the user of its own terminal, but the invention is not limited thereto. For example, the present state may be estimated based on sensor data acquired by the portable terminal 1b and profile information on the user of the portable terminal 1a.

Further, in the above-described embodiment, an example in which the profile information acquisition unit 12 acquires a place profile of the meaning given to a place for each user has been described, but the profile information acquisition unit 12 may acquire a profile of the meaning given to a time for each user. In this case, for example, the shareability determination unit 14 may allow data sharing on only a holiday for a user.

In addition, the detection unit 11 may acquire a cell ID for specifying a base station to which its own terminal 1b is connected through mobile communication. In this case, the cell ID may be used as positional information.

In addition, the detection unit 11 may acquire the use state of an application installed in the portable terminal 1 as sensor data used for the estimation of a profile. In this case, interests and tastes may be estimated based on the use state of the application, and for example, the degree of consistency of the interests and tastes may be added to parameters of an intimacy degree. In addition, the detection unit 11 may acquire a Web browsing history of a portable terminal, a battery residual quantity, acceleration sensor information, and the like in order to use these for the estimation of a profile.

Further, in the above-described embodiment, an example in which the shareability determination device is constituted by the portable terminal 1 has been described, but the shareability determination device may be constituted by, for example, an attribute estimation server. In this case, context may be estimated by the attribute estimation server.

Meanwhile, the block diagrams used in the above-described embodiment represent blocks in units of functions. These functional blocks (constituent elements) are realized by any combination of hardware and/or software. In addition, means for realizing each functional block is not particularly limited. That is, each functional block may be realized by one device which is physically and/or logically coupled, or may be realized by two or more devices which are physically and/or logically away from each other by connecting the plurality of devices directly and/or indirectly (for example, in a wired manner and/or in a wireless manner).

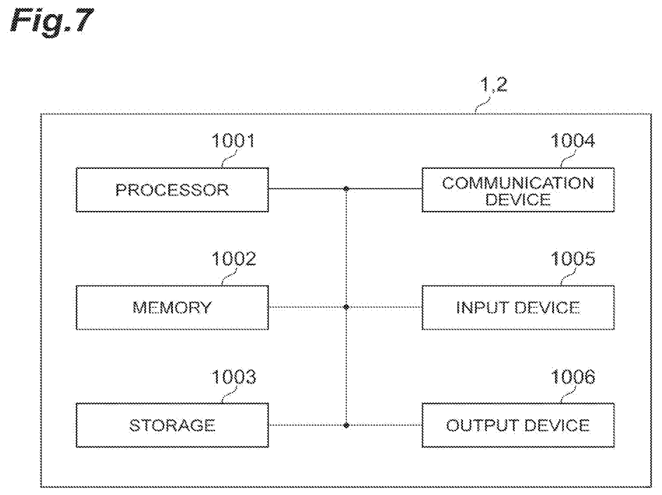

For example, the portable terminal 1 and the profile estimation server 2 in the embodiment of the present invention may function as a computer performing processes of the portable terminal 1 and the profile estimation server 2 of the present embodiment. FIG. 7 is a diagram illustrating an example of hardware configurations of the portable terminal 1 and the profile estimation server 2 according to the present embodiment. The above-described portable terminal 1 and profile estimation server 2 may be physically configured as a computer device including a processor 1001, a memory 1002, a storage 1003, a communication device 1004, an input device 1005, an output device 1006, a bus 1007, and the like.

Meanwhile, in the following description, the wording “device” may be replaced by a circuit, a unit, or the like. The hardware configurations of the portable terminal 1 and the profile estimation server 2 may be configured to include one or a plurality of devices shown in FIG. 8, or may be configured without including some of these devices.

The processor 1001 performs an arithmetic operation by reading predetermined software (program) onto hardware such as the processor 1001 or the memory 1002, and thus each function in the portable terminal 1 and the profile estimation server 2 is realized by controlling communication in the communication device 1004 or reading and/or writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like. For example, the functional units of the portable terminal 1 and the profile estimation server 2 described above may be realized by the processor 1001.

In addition, the processor 1001 reads out a program (program code), a software module and data from the storage 1003 and/or the communication device 1004 into the memory 1002, and executes various types of processes in accordance therewith. An example of the program which is used includes a program causing a computer to execute at least some of the operations described in the above-described embodiment. For example, the functional units of the portable terminal 1 and the profile estimation server 2 arc stored in the memory 1002, and may be realized by a control program which is operated by the processor 1001. The execution of various types of processes described above by one processor 1001 has been described, but these processes may be simultaneously or sequentially executed by two or more processors 1001. The processor 1001 may be realized using one or more chips. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can store a program (program code), a software module, or the like that can be executed in order to carry out a method according to the embodiment of the present invention.

The storage 1003 is a computer readable recording medium, and may be constituted by at least one of, for example, an optical disc such as a compact disc ROM (CD-ROM), a hard disk drive, a flexible disk, a magnetooptic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The foregoing storage medium may be, for example, a database including the memory 1002 and/or the storage 1003, a server, or other suitable mediums.

The communication device 1004 is hardware (transmitting and receiving device) for performing communication between computers through a wired and/or wireless network, and is also referred to as, for example, a network device, a network controller, a network card, a communication module, or the like. For example, the above-described detection unit 11, profile information acquisition unit 12, sharing data transmission unit 15, sensor data storage unit 21, profile information transmission unit 24, and the like may be realized to include the communication device 1004.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel).

In addition, each device of the processor 1001, the memory 1002, and the like is connected through the bus 1007 for communicating information. The bus 1007 may be constituted by a single bus, or may be constituted by different buses between devices.

In addition, each of the portable terminal 1 and the profile estimation server 2 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, the processor 1001 may be realized using at least one of these pieces of hardware.

Hereinbefore, the present embodiments have been described in detail, but it is apparent to those skilled in the art that the present embodiments should not be limited to the embodiments described in this specification. The present embodiments can be implemented as modified and changed aspects without departing from the spirit and scope of the present invention, which are determined by the description of the scope of claims. Therefore, the description of this specification is intended for illustrative explanation only, and does not impose any limited interpretation on the present embodiments.

The aspects/embodiments described in this specification may be applied to systems employing long term evolution (LTE), LTE-advanced (LTE-A), SUPER 3G, IMT-Advanced, 4G, 5G, future radio access (FR A), W-CDMA (registered trademark), GSM (registered trademark), CDMA2000, ultra-mobile broadband (UMB), IEEE 802.11 (Wi-Fi), IEEE 802.16 (WiMAX), IEEE 802.20, ultra-wideband (UWB), Bluetooth (registered trademark), or other appropriate systems and/or next-generation systems to which these systems are extended on the basis thereof.

The order of the processing sequences, the sequences, the flowcharts, and the like of the aspects/embodiments described above in this specification may be changed as long as they are compatible with each other. For example, in the methods described in this specification, various steps as elements are described in an exemplary order but the methods are not limited to the described order.

The input or output information or the like may be stored in a specific place (for example, a memory) or may be managed in a management table. The input or output information or the like may be overwritten, updated, or added. The output information or the like may be deleted. The input information or the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects described in this specification may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Regardless of whether it is called software, firmware, middleware, microcode, hardware description language, or another name, software can be widely construed to refer to commands, a command set, codes, code segments, program codes, a program, a sub-program, a software module, an application, a software application, a software package, a routine, a sub-routine, an object, an executable file, an execution thread, an order, a function, or the like.

In addition, Software, a command, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, the wired technology and/or the wireless technology are included in the definition of a transmission medium.

Information, a signal or the like described in this specification may be expressed using any of various different techniques. For example, data, an instruction, a command, information, a signal, a bit, a symbol, and a chip which can be mentioned in the overall description may be expressed by a voltage, a current, an electromagnetic wave, a magnetic field or magnetic particles, an optical field or photons, or any combination thereof.

Meanwhile, the terms described in this specification and/or the terms required for understanding this specification may be substituted by terms having the same or similar meanings.

The terms “system” and “network” which are used in this specification are used interchangeably.

In addition, information, parameters, and the like described in this specification may be expressed as absolute values, may be expressed by values relative to a predetermined value, or may be expressed by other corresponding information.

A mobile communication terminal may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms by those skilled in the art.

The taint “determining” which is used in this specification may include various types of operations. The term “determining” may include regarding operations such as, for example, judging, calculating, computing, processing, deriving, investigating, looking up (for example, looking up in a table, a database or a separate data structure), or ascertaining as an operation such as “determining.” In addition, the term “determining” may include regarding operations such as receiving (for example, receiving information), transmitting (for example, transmitting information), input, output, or accessing (for example, accessing data in a memory) as an operation such as “determining.” In addition, the term “determining” may include regarding operations such as resolving, selecting, choosing, establishing, or comparing as an operation such as “determining.” That is, the term “determining” may include regarding some kind of operation as an operation such as “determining.”

An expression “based on” which is used in this specification does not refer to only “based on only,” unless otherwise described. In other words, the expression “based on” refers to both “based on only” and “based on at least.”

Insofar as the terms “include” and “including” and modifications thereof are used in this specification or the claims, these terms are intended to have a comprehensive meaning similarly to the term “comprising.” Further, the term “or” which is used in this specification or the claims is intended not to mean an exclusive logical sum. In this specification, a single device is assumed to include a plurality of devices unless only one device may be present in view of the context or the technique.

In the entire disclosure, a singular form is intended to include a plural form unless the context indicates otherwise.

### REFERENCE SIGNS LIST

1a (1) The other terminal (portable terminal)
1b (1) Its own terminal (portable terminal)
11 Detection unit
12 Profile information acquisition unit (attribute information acquisition unit)
13 Context estimation unit (state estimation unit)
14 Shareability determination unit

1. A data sharing determination device comprising circuitry configured to:
detect that two portable terminals are close to each other;
acquire attribute information indicating an attribute of at least one of users of the two portable terminals;
acquire sensor information of one or a plurality of sensors included in any one of the two portable terminals and estimate a state of at least one of the users based on the sensor information and the attribute information; and
determine whether or not data may be shared between the two portable terminals based on the state of the user.

2. The data sharing determination device according to claim 1,
wherein the circuitry acquires at least one of relationship information indicating a relationship between the users and intimacy information indicating an intimacy degree between the users as the attribute information.

3. The data sharing determination device according to claim 1,
wherein the circuitry acquires classification information of meaning given to a place or a time for each user as the attribute information.

4. The data sharing determination device according to claim 1,
wherein the data is generated in the state estimated.

5. The data sharing determination device according to claim 1,
wherein the data sharing determination device is one of the two portable terminals, and
the circuitry detects the other portable terminal out of the two portable terminals through near-field wireless communication.

6. The data sharing determination device according to claim 2,
wherein the circuitry acquires classification information of meaning given to a place or a time for each user as the attribute information.
